(19) United States
(12) Patent Application Publication
(10) Pub. No.: US 2010/0166355 A1
(43) Pub. Date: Jul. 1, 2010

(54) METAL CAGE FOR ROLLER BEARING

(75) Inventors: Thorsten Schlegel, Frankenbrunn (DE); Rudolf Zeidlhack, Werneck (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, HERZOGENAURACH (DE)

(21) Appl. No.: 12/444,444

(22) PCT Filed: Sep. 15, 2007
(86) PCT No.: PCT/DE07/01670

§ 371 Date: May 7, 2009

(30) Foreign Application Priority Data
Oct. 7, 2006 (DE) 10 2006 047 554.7

(51) Int. Cl. F16C 33/48

(52) U.S. Cl. 384/572

(57) ABSTRACT

Metal cage for roller bearings, comprising two cage side parts, between which the rollers are held, wherein a plurality of holding elements which permanently connect the cage side parts to one another are arranged essentially parallel to the rotational axis of the rollers which are held between two holding elements, are not rotatably mounted on the cage side parts and are spaced apart from the holding elements.

### FIELD OF THE INVENTION

The invention relates to a metal cage for roller bearings, comprising two cage side parts between which the rollers are held.

### BACKGROUND OF THE INVENTION

Metal cages of said type are used in particular in bearings of large dimensions. Examples here are large, double-row tapered-roller bearings for wind-power plants (rotor bearings) with outer diameters of greater than 1500 mm. Metal cages of said type are however also fundamentally suitable for a wide variety of rolling bearing types with rollers as rolling bodies, in particular for relatively large radial and axial roller bearings, radial and axial self-aligning roller bearings, radial and axial tapered-roller bearings and special types, for example combined multi-row roller bearings or angular-contact roller bearings. The metal cage serves to hold and guide the rollers. A metal cage of said type is for example known from DE 26 08 308 A1. Said metal cage comprises two cage side parts which, in the radial bearing shown in said documents, are designed as rings, and which are fixed to one another by means of a small number of transverse connections. Between the cage side parts, the individual rollers are each rotatably mounted in each case separately on the cage side parts. For this purpose, corresponding recesses are provided in the cage side parts, and into which short pins are inserted; the pins, with their ends which form an extension in relation to the section which is inserted in the side part, engage into a corresponding recess on the respective roller end side. At said end, a convex projection is integrally formed on the pin, which projection is held in a depression, which is concentric with respect to the roller axis, on the base of the blind bore on the roller end side. Said cage design is very complex, since it is necessary to provide special bearing pins, and the rollers themselves must be designed correspondingly.

Also known is a so-called pin cage, which is a solid cage whose pins extend through the bores of rollers which are provided with axial through bores. It is therefore the case here that all of the rollers are provided with a bore, through which one pin which connects the two cage side parts is each guided as a rotary axle. The production costs even of a pin cage of said type are considerable, since the pins must be hardened, ground and surface-treated, and the rollers must be provided with through bores.

### SUMMARY OF THE INVENTION

The invention is therefore based on the problem of specifying a metal cage for roller bearings, which metal cage is of simpler design.

According to the invention, to solve said problem, in a metal cage of the type specified in the introduction, a plurality of retaining elements are provided which fixedly connect the ball side parts to one another and which are arranged substantially parallel to the rotary axis of the rollers which are held between two retaining elements and which are not rotatably mounted on the cage side parts and which are spaced apart by the retaining elements.

In the metal cage according to the invention, the two cage side parts are connected by means of a multiplicity of retaining elements which extend between the two side parts. Said retaining elements serve exclusively to connect the cage side parts, and do not serve to mount the rollers. Said rollers are situated between the retaining elements, and are spaced apart from the latter. To fix them, use is made of separate spacers, which are explained in more detail below. The metal cage and the loosely mounted rollers form the ring of rollers which is arranged between two raceways.

Since the retaining elements do not perform the function of an axle, because the rollers are merely inserted in the region between two retaining elements, the production of a metal cage according to the invention is simplified significantly, and as a result, the construction of a roller bearing containing a cage of said type is ultimately also simplified.

According to a first alternative of the invention, the retaining elements may be formed as separate components, for example in the form of cylindrical retaining pins or angular retaining webs, which are connected to the cage sides. This may take place by means of insertion into corresponding recesses on the cage side parts, screwing, welding or the like. In any case, the retaining elements are situated in a region to the side of the rollers.

An alternative to the construction of the metal cage from separate cage side parts and retaining elements provides that the cage is produced as a single-piece cast part. It is therefore the case here that the cage side parts and the retaining parts are cast together, and it is merely necessary to carry out a small amount of machine finishing in order to remove corresponding casting seams or the like. Said embodiment also generates a stable metal cage which provides the roller bearing to be produced with an adequate degree of stability. It is also the case here that the retaining elements may be round or polygonal in cross section.

As described, the retaining elements are spaced apart from the rollers, that is to say said retaining elements do not come into contact with said rollers. The rollers run on two running surfaces, which are situated opposite one another, of two mutually opposite rings on which said rollers are counter-mounted. To be able to provide sufficient guidance to the two rollers between two retaining elements, such that said rollers remain in their position between the retaining elements, corresponding spacers are expediently provided which can preferably be detachably fixed to the retaining elements. For this purpose, sections for detachably fastening spacers, which are to be positioned between two rollers and which space the latter apart from one another, are provided on the retaining elements. Said spacers may be formed as small plastic or metal elements and are detachably fastened to the corresponding sections on the retaining elements. Said spacers engage between two adjacent rollers, and the rollers are guided between two spacers, such that said rollers cannot come into contact with one another or the retaining elements. The sections on the retaining elements themselves may be embodied as cross-sectional constrictions or as plug-through receptacles. A corresponding spacer, which is designed as a latching clip, is plugged, for example, onto a constriction of said type, that is to say a reduction of the diameter of the retaining pin, such that said spacer correspondingly engages with its respective retaining or guiding section between two rollers. Also conceivable, however, is a plug-through recess for example on a rectangular or flat retaining element, through which plug-through recess the spacer is plugged, and in which plug-through recess said spacer is latched. In these described embodiments of the invention, a retaining element is provided between two rollers each to be positioned.

One alternative of the invention provides that, in the assembled position, one, two or more retaining elements are arranged between two rollers, which retaining elements serve to support a spacer which is to be guided between said retaining elements and which is mounted on said retaining elements. While it is the case in the above-described embodiment that, for example, a retaining clip is latched onto the constriction or a retaining clip is plugged and latched into the plug-through recess, it is the case in the embodiment of the invention with two retaining elements arranged between the rollers that the spacer is mounted on said retaining elements, wherein it is preferable when an aperture for holding a fixing element, which serves to fix a spacer which is to be inserted, is provided on the cage side parts, in each case the two retaining elements which are positioned between two rollers. In said embodiment of the invention, the retaining elements serve merely to provide support, while the spacer is then held in its position between two rollers, and is prevented from tilting, by means of a separate, preferably pin-like fixing element.

It is likewise possible for a plurality of further retaining elements, which serve as axle pins for rollers with through bores, to be provided. Said further small number of retaining elements should expediently be arranged so as to be distributed virtually uniformly or symmetrically about the periphery of the cage. Said embodiment of the invention is particularly expedient in the case of the metal cage being formed with two separate cage side parts and separate retaining elements. Said small number of retaining elements, which form a rotary axle, serve primarily to provide stable, precise cage guidance and to hold the cage weight, that is to say the weight of the cage is supported on one of the bearing rings via the axle pins and rollers.

In addition to the metal cage, the invention also relates to a roller bearing comprising two rings and at least one metal cage, which contains rollers, of the described type.

### BRIEF DESCRIPTION OF THE DRAWINGS

Further advantages, features and details of the invention can be gathered from the following description of the exemplary embodiments, in which:

FIG. 1 shows a partial view of a metal cage according to the invention of a first embodiment, with rollers and spacers indicated by dashed lines;

FIG. 2 shows a section view through a roller bearing according to the invention comprising the metal cage from FIG. 1; and

FIG. 3 shows an illustration of a metal cage of a second embodiment with spacers and rollers indicated by dashed lines.

### DETAILED DESCRIPTION OF THE DRAWINGS

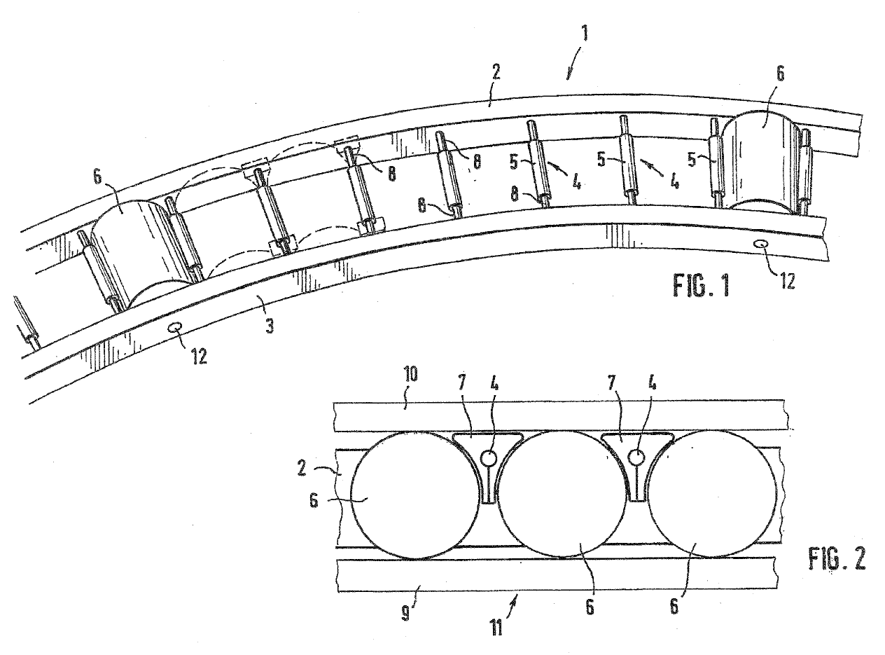

FIG. 1 shows a metal cage 1 according to the invention without rollers in the form of a partial view. Said metal cage 1 is composed of two cage side parts 2, 3, with the metal cage 1 being used here, by way of example, in the construction of an axial roller bearing. As a result, it is the case here that the radius of the inner cage side part 3, which is embodied as a ring, is slightly smaller than the radius of the outer annular cage side part 2. The two cage side parts 2, 3 are fixedly connected to one another by means of retaining elements 4, in this case in the form of cylindrical retaining pins 5, so as to form a stable metal cage. Here, the retaining elements 4 are thus separate components which are fixed into a corresponding position on the cage side parts 2, 3. For this purpose, the cage side parts 2, 3 may have corresponding threaded or passage bores into which the ends of the retaining pins 5 are plugged, after which the retaining pins 5 may also for example be welded. It would also be conceivable for said retaining pins 5 to be fastened by means of a screw connection. The retaining pins 5 are spaced apart equidistantly from one another about the periphery. Said retaining pins 5 serve exclusively to fix the two cage side parts 2, 3 to one another and do not perform the function of forming a rotary axis. The individual rollers 6 are arranged between two retaining elements (see the illustration of FIG. 2). The rollers 6 themselves do not come into contact with the retaining elements 4. To guide the rollers 6 and to fix the position of the rollers, spacers 7 are arranged on the retaining elements 4. Said spacers 7 may for example be designed as longitudinally slotted retaining clips which are fastened to corresponding fixing sections 8 on the retaining elements 4. In the example shown, said sections 8 are formed using the retaining pins 5 as end-side diameter constrictions, onto which may be snapped a spacer 7 which has a corresponding retaining aperture or the like. In each case one constriction 8 is provided on the ends of the retaining elements 4, such that in each case two spacers 7 may thus be fastened to each retaining element 4. Said spacers 7 now engage slightly over the roller, see FIG. 2, and also engage with their lower section between the two rollers 4, such that said rollers are spaced apart and guided. The spacer elements 7 engage on the rollers 6 only at the edge side. Said rollers 6 are thus engaged over slightly only at the edges, and the rest of the roller region is available for lubrication. The rollers 6 themselves are, so to speak, mounted loosely, and have no bearing connection to the metal cage 1 itself. Said rollers 6 are merely supported on the lower ring 9 and on the upper ring 10 of the roller bearing 11 shown in FIG. 2.

As is also shown in FIG. 1, it is possible for reasons of stability for a small number of rollers 6 to be rotatably mounted directly on the cage side parts 2, 3. The two rollers 6 which are shown here are provided with central through bores, and a bearing pin 12 engages through said rollers 6, which bearing pin 12 is fastened at the end side to the cage side parts 2, 3 and forms the rotary axis for said rollers. The weight of the cage is supported, and more precise guidance of the cage is obtained, via said small number of bearing pins or axle pins.

For example, even three rollers 6 which are directly mounted so as to be distributed equidistantly about the periphery are basically sufficient, though it is also possible to provide a few more. In any case, the majority of the rollers 6 are not rotatably mounted on the cage side parts 2, 3 in the case of the metal cage according to the invention.

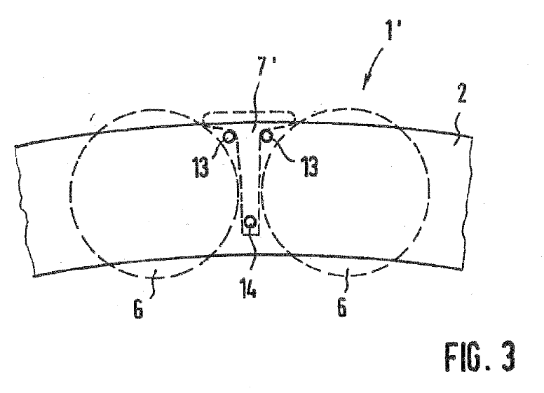

FIG. 3 shows a further embodiment of a metal cage 1′, wherein here, only a side view of the outer cage side part 2 is shown. Two bores 13 are provided on said outer cage side part 2, which bores 13 serve to hold in each case one end of a retaining element 4, preferably a retaining pin 5. In said embodiment of the invention, therefore, two retaining pins 5 are situated in the region between two rollers 6 (shown here by dashed lines), offset upward out of the plane of rotation of the rollers 6, in contrast to the embodiment according to FIG. 1, where only one retaining pin 5 is positioned between two rollers 6. In the assembled position, the spacer 7′ is supported on the corresponding sections 8 of the two inserted retaining pins 5 (not shown in any more detail here, however); said spacer 7′ is mounted on said sections 8. To fix the spacer 7′, a further bore 14 is provided on the cage side part 2 on the opposite side, through which further bore 14 extends a fixing element, preferably likewise a pin, and extends through a corresponding aperture in the retaining element 7′. In this way, the retaining element 7′ is fixed in its position in which it, supported on the retaining elements, on the one hand engages slightly over the rollers 6 in their edge region, and on the other hand spaces the rollers apart in the region between them via its elongate section. The spacer, which is basically formed as a sliding element in all embodiments, and which may be formed from plastic or metal (for example brass), thus fixes the rollers in their position and prevents the rollers from coming into contact with one another and with the retaining elements.

The metal cage according to the invention is still sufficiently stable even though the rollers are no longer rotatably mounted directly thereon. Any welding operations for connecting the retaining elements 4 to the cage side parts 2, 3 may be carried out away from the bearing, that is to say, since the rollers are mounted “loosely”, the cage may be pre-manufactured, so to speak. The high utilization of the circumference, that is to say the high number of rolling bodies, is also maintained here, since the rollers can be arranged very closely adjacent to one another, separated only by the relatively narrow webs of the spacers. As a result of the plastic or metal spacers which are used, which mount and guide the rollers, a low level of bearing friction torque is also obtained, also on account of the fact that the spacers come into contact with the rollers only in the edge region thereof. The rolling bodies themselves may, aside from the small number of rollers optionally provided which are mounted directly by means of the axle pins, be produced from cost-effective rolling bearing steel, and it is no longer necessary for said rollers to be produced from case-hardened steel and provided with through bores, such that overall, the production costs of the metal cage and also of the rolling body set can be reduced.

An alternative embodiment of a metal cage is conceivable in which, instead of cylindrical retaining pins 5, tetragonal retaining webs are provided which have a plug-through aperture through which a spacer with an elongate section, which is to be arranged between two rollers, is guided, in which aperture said spacer is then latched. The spacer self-evidently also has a corresponding upper section, by means of which it engages laterally over the rollers.

A further conceivable embodiment provides that a single-part metal cage is produced in the form of a cast part, that is to say the cage side parts 2, 3 and the retaining element 4 are produced in the form of a single-piece component using a corresponding casting mold. The cast part merely needs to be machine finished to a small extent. It is also the case here that the retaining elements may be formed in the manner of a round pin or as a polygonal web, so as to allow a suitable spacer element to be snapped on or plugged in.

### List of Reference Symbols

1 Metal cage
1′ Metal cage
2 Cage side part
3 Cage side part
4 Retaining element
5 Retaining pins
6 Rollers
7 Spacer
7′ Spacer
8 Fixing section
9 Lower ring
10 Upper ring
11 Roller bearing
12 Bearing or axle pin
13 Bores
14 Bore

1. A metal cage for roller bearings, comprising two cage side parts between which the rollers are held, a plurality of retaining elements fixedly connect the cage side parts to one another and are arranged substantially parallel to a rotary axis of the rollers which are held between two retaining elements and which are not rotatably mounted on the cage side parts and which are spaced apart by the retaining elements.

2. The metal cage as claimed in claim 1, wherein the retaining elements are connected, as separate components, to the cage side parts.

3. The metal cage as claimed in claim 2, wherein the retaining elements are retaining pins or retaining webs.

4. The metal cage as claimed in claim 1, wherein the metal cage is a single-piece cast part.

5. The metal cage as claimed in claim 4, wherein the retaining elements are round or polygonal in cross-section.

6. The metal cage as claimed in claim 1, wherein sections for detachably fastening spacers, which are positioned between two of the rollers and which space the rollers apart from one another, are provided on the retaining elements.

7. The metal cage as claimed in claim 6, wherein the sections are formed as cross-sectional constrictions or as plug-through recesses.

8. The metal cage as claimed in claim 1, wherein, in an assembled position, retaining elements are arranged between two of the rollers, the retaining elements serve to support a spacer which is guided between the retaining elements and which is mounted on the retaining elements.

9. The metal cage as claimed in claim 8, wherein an aperture for holding a fixing element, which serves to fix a spacer, is provided on each of the cage side parts, between the two retaining elements, which are positioned between the two rollers.

10. The metal cage as claimed in claim 2, wherein a plurality of further retaining elements, which serve as axle pins for rollers with through bores, are provided.

11. The metal cage as claimed in claim 10, wherein the further retaining elements are distributed symmetrically about the periphery of the cage.

12. A roller bearing comprising two rings and at least one metal cage, which contains rollers, as claimed in claim 1.
